(19) United States
(12) Patent Application Publication
(10) Pub. No.: US 2022/0287085 A1
(43) Pub. Date: Sep. 8, 2022

(54) USER TERMINAL AND RADIO COMMUNICATION METHOD

(71) Applicant: NTT DOCOMO, INC., Tokyo (JP)

(72) Inventors: Daisuke Murayama, Tokyo (JP); Hiroki Harada, Tokyo (JP)

(73) Assignee: NTT DOCOMO, INC., Tokyo (JP)

(21) Appl. No.: 17/608,087

(22) PCT Filed: May 2, 2019
(86) PCT No.: PCT/JP2019/018189

§ 371 Date: Nov. 1, 2021

(51) Int. Cl. H04W 74/08; H04W 16/14

(52) U.S. Cl. CPC H04W 74/0808; H04W 16/14

(57) ABSTRACT

A user terminal includes a receiving section that measures received power in a frequency in which channel sensing is applied, and a control section that performs transmission in the frequency on the basis of sensing within random time in a contention window size (CWS) based on the measurement. According to an aspect of the present disclosure, it is possible to perform appropriate communication in an unlicensed band.

### TECHNICAL FIELD

The present disclosure relates to a user terminal and a radio communication method in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (e.g., referred to as “5th generation mobile communication system (5G),” “5G plus (+),” “New Radio (NR),” “3GPP Rel. 15 (or later versions),” and so on) are also under study.

In an existing LTE system (e.g., Rel. 8 to Rel. 12), specifications have been conducted based on an assumption that the system is exclusively operated in a frequency band (referred to as a licensed band, a licensed carrier, a licensed component carrier (licensed CC), and so on) licensed to a communication carrier (operator). For example, 800 MHz, 1.7 GHz, 2 GHz, and the like are used as the licensed CC.

In existing LTE systems (e.g., Rel. 13), in order to expand a frequency band, use of a frequency band different from the above-described licensed band (referred to as an unlicensed band, an unlicensed carrier, or an unlicensed CC) is supported. The unlicensed band is assumed to be, for example, a 2.4 GHz band, a 5 GHz band, and the like in which Wi-Fi (registered trademark) and Bluetooth (registered trademark) can be used.

Specifically, in Rel. 13, carrier aggregation (CA) that aggregates a carrier (CC) in the licensed band with a carrier (CC) in the unlicensed band is supported. Communication thus performed by using the unlicensed band together with the licensed band is referred to as License-Assisted Access (LAA).

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication systems (e.g., 5G, 5G+, NR, and Rel. 15 (or later versions)), a transmitting apparatus (which is, for example, a base station in downlink (DL), and is, for example, a user terminal in uplink (UL)) performs listening to check the presence or absence of transmission by another apparatus (e.g., a base station, a user terminal, a Wi-Fi apparatus, or the like) before transmission of data in an unlicensed band.

It is conceivable that such radio communication systems are in accordance with regulation or requirement in the unlicensed band in order to coexist with another system in the unlicensed band.

However, unless an operation in the unlicensed band is definitely determined, an appropriate communication in the unlicensed band may be unavailable, such as an operation non-compliant with the regulation under specific communication conditions, reduction in utilization efficiency of radio resources, and the like.

Thus, an object of the present disclosure is to provide a user terminal and a radio communication method that perform appropriate communication in an unlicensed band.

### Solution to Problem

A user terminal according to an aspect of the present disclosure includes a receiving section that measures received power in a frequency in which channel sensing is applied, and a control section that performs transmission in the frequency on the basis of sensing within random time in a contention window size (CWS) based on the measurement.

### Advantageous Effects of Invention

According to an aspect of the present disclosure, it is possible to perform appropriate communication in an unlicensed band.

### BRIEF DESCRIPTION OF DRAWINGS

FIG. 1 is a diagram to show an example of CSMA/CA with ACK;

FIG. 2 is a diagram to show an example of data collision due to a hidden terminal;

FIG. 3 is a diagram to show an example of CSMA/CA with RTS/CTS;

FIG. 4 is a diagram to show an example of RTS/CTS in an NR-U system;

FIG. 5 is a diagram to show an example of channel occupancy measurement;

FIG. 6 is a diagram to show an example of an association between congestion parameter ranges and CWS parameter values;

FIG. 7 is a diagram to show another example of the association between the congestion parameter ranges and the CWS parameter values;

FIG. 8 is a diagram to show an example of an association between congestion parameter ranges and CWS update methods;

FIG. 9 is a diagram to show an example of a schematic structure of a radio communication system according to one embodiment;

FIG. 10 is a diagram to show an example of a structure of a base station according to one embodiment;

FIG. 11 is a diagram to show an example of a structure of a user terminal according to one embodiment; and

FIG. 12 is a diagram to show an example of a hardware structure of the base station and the user terminal according to one embodiment.

### DESCRIPTION OF EMBODIMENTS

### <Collision Avoidance Method in Unlicensed Band>

In an unlicensed band (e.g., a 2.4 GHz band or a 5 GHz band), for example, it is assumed that a plurality of systems, such as a Wi-Fi system, a system (LAA system) that supports LAA, and the like, coexists, and thus it is conceivable that collision avoidance and/or interference control of transmissions between the plurality of systems are necessary.

An NR system (referred to as, for example, 5G, 5G+, NR, 3GPP Rel. 15 (or later versions), and so on) that uses the unlicensed band may be referred to as an NR-Unlicensed (U) system, an NR LAA system, and so on. Dual connectivity (DC) of a licensed band and the unlicensed band, stand-alone (SA) for the unlicensed band, and the like are possibly employed in NR-U as well.

For example, in the Wi-Fi system that uses the unlicensed band, Carrier Sense Multiple Access (CSMA)/Collision Avoidance (CA) are employed for the purpose of the collision avoidance and/or interference control.

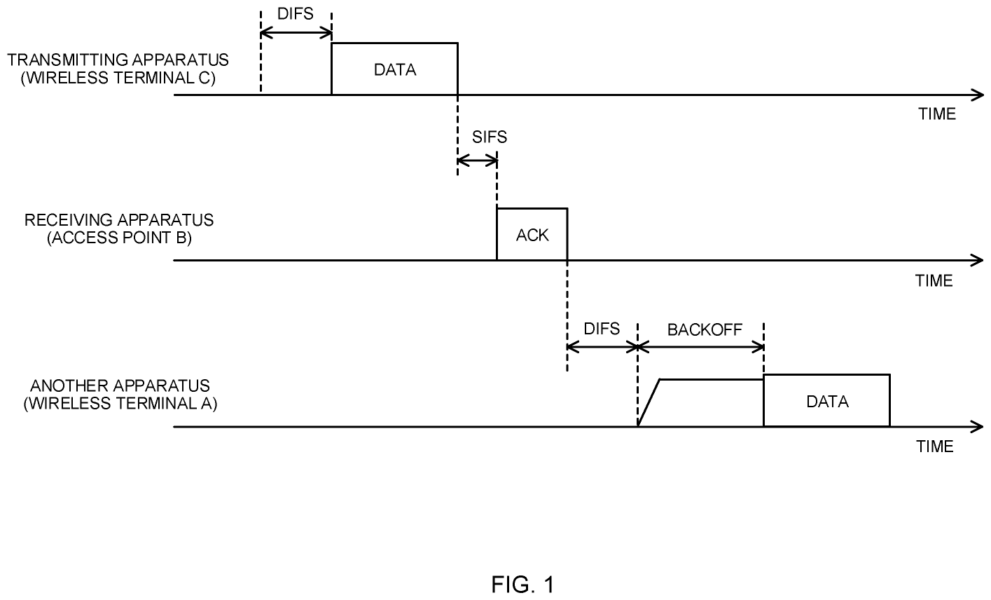

FIG. 1 is a diagram to show an example of CSMA/CA. As shown in FIG. 1, a wireless terminal C (data transmission side) checks (carrier sense) a signal on a communication medium, and does not start data transmission soon after judging that there is no signal but transmits data after waiting for given time. This waiting time is referred to as Distributed access Inter Frame Space (DIFS). An access point B (data reception side) that has received the data returns an acknowledgement (ACK). In order to allow the ACK to be transmitted with priority, just waiting for time (SIFS (Short IFS)) shorter than the DIFS allows the ACK to be transmitted. The wireless terminal C (data transmission side) repeats retransmission until reception of the ACK. Thus, an access scheme (first access scheme) shown in FIG. 1 is referred to as CSMA/CA with ACK.

In the Wi-Fi system, for the purpose of collision avoidance and/or interference control, Request to Send/Clear to Send (RTS/CTS) is employed in which transmission request (Request to Send (RTS)) is transmitted before transmission and receivable (Clear to Send (CTS)) is transmitted as a response when the receiving apparatus receivable. For example, RTS/CTS is effective in avoidance of data collision due to a hidden terminal. When a signal from a given node reaches a receiving apparatus instead of reaching a transmitting apparatus, the node is referred to as a hidden terminal (hidden node) for the transmitting apparatus. The hidden terminal may be referred to as a node that is not detected, a node that is not sensed, and so on. Data collision due to the hidden terminal may be referred to as a hidden terminal problem (hidden node problem).

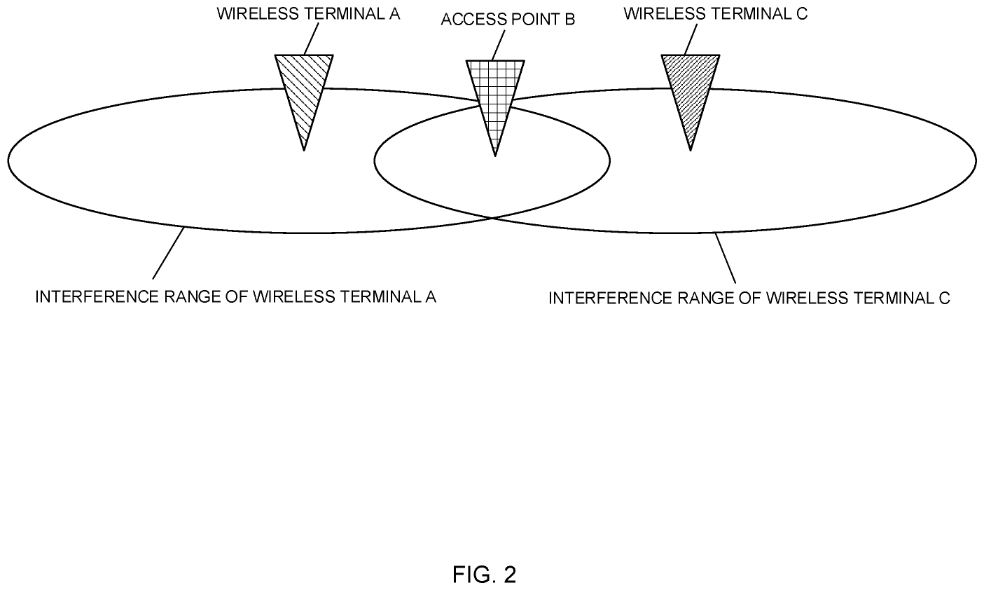

FIG. 2 is a diagram to show an example of data collision due to the hidden terminal. In FIG. 2, a radio wave of the wireless terminal C does not reach a wireless terminal A, and thus the wireless terminal A fails to detect a transmission signal from the wireless terminal C even though the wireless terminal A performs a carrier sense before transmission. Consequently, it is assumed that the wireless terminal A transmits a transmission signal to the access point B even while the wireless terminal C is transmitting the transmission signal to the access point B. In this case, transmission signals from wireless terminals A and C may collide in the access point B, and throughput may be reduced.

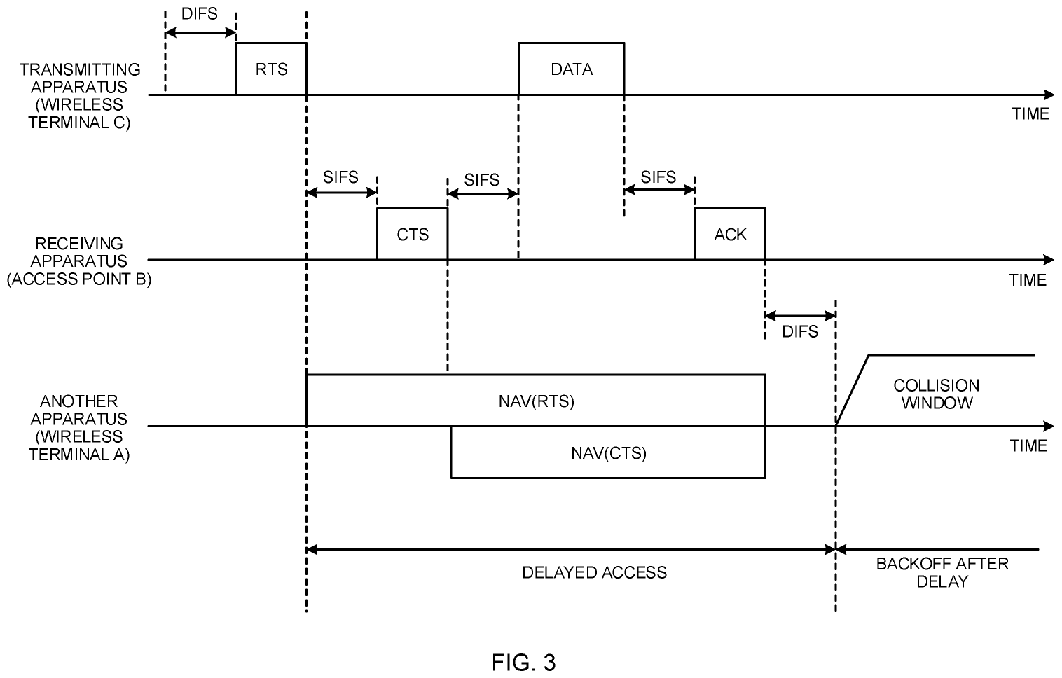

FIG. 3 is a diagram to show an example of CSMA/CA with RTS/CTS. As shown in FIG. 3, the wireless terminal C (data transmission side) transmits RTS (note that in FIG. 2, the RTS does not reach the wireless terminal A (another terminal)) in response to detecting the absence (idle) of another transmission signal by performing a carrier sense in given time (DIFS) before transmission. It is preferable that the RTS is omni (omni-directional)-transmission. Beam forming may be performed for the RTS. When receiving RTS from the wireless terminal C, the access point B (reception side) transmits CTS in response to detecting the absence (idle or clear) of another transmission signal by performing a carrier sense in given time (Short Inter Frame Space (SIFS)). It is preferable that the CTS is omni-transmission. The RTS may be referred to as a transmission request signal. The CTS may be referred to as a receivable signal.

In FIG. 2, the CTS from the access point B also reaches the wireless terminal A (another apparatus), and thus the wireless terminal A senses that communication is to be performed, and postpones transmission. A given period (referred to as Network Allocation Vector (NAV) or prohibited transmission period and so on) is specified in an RTS/CTS packet, and thus communication is pending during the given period (NAV indicated by RTS “NAV (RTS)” or NAV indicated by CTS “NAV (CTS)”).

The wireless terminal C that has received the CTS from the access point B transmits data (frame) in response to detecting the absence (idle) of another transmission signal by performing a carrier sense in a given period (SIFS) before transmission. The access point B that has received the data transmits ACK after the given period (SIFS).

In FIG. 3, when detecting CTS from the access point B, the wireless terminal A that is a hidden terminal relative to the wireless terminal C postpones transmission, and thus collision of transmission signals from the wireless terminals A and C in the access point B can be avoided.

In LAA with existing LTE systems (e.g., Rel. 13), a data transmitting apparatus performs listening (referred to as LBT, CCA, a carrier sense, channel access procedure, or the like) to check the presence or absence of transmission by another apparatus (e.g., a base station, a user terminal, a Wi-Fi apparatus, or the like) before data transmission in an unlicensed band.

The transmitting apparatus may be, for example, a base station (e.g., gNodeB (gNB), a transmission/reception point (TRP), or a network (NW)) in downlink (DL), and may be, for example, a user terminal (e.g., a User Equipment (UE)) in uplink (UL). The receiving apparatus that receives data from the transmitting apparatus may be, for example, a user terminal in DL, and may be, for example, a base station in UL.

In LAA with the existing LTE systems, the transmitting apparatus starts data transmission after a given period (e.g., a period immediately after or a backoff period) from detection of the absence (idle state) of transmission by another apparatus in the listening, and does not perform data transmission when the presence (busy state) of transmission by another apparatus is detected in the listening. However, even when the transmitting apparatus transmits data on the basis of the listening result, it may not avoid data collision in the receiving apparatus due to existence of the above-described hidden terminal.

Thus, for NR-U systems, supporting the above-mentioned RTS/CTS in order to enhance an avoidance rate of data collision in the receiving apparatus is under study.

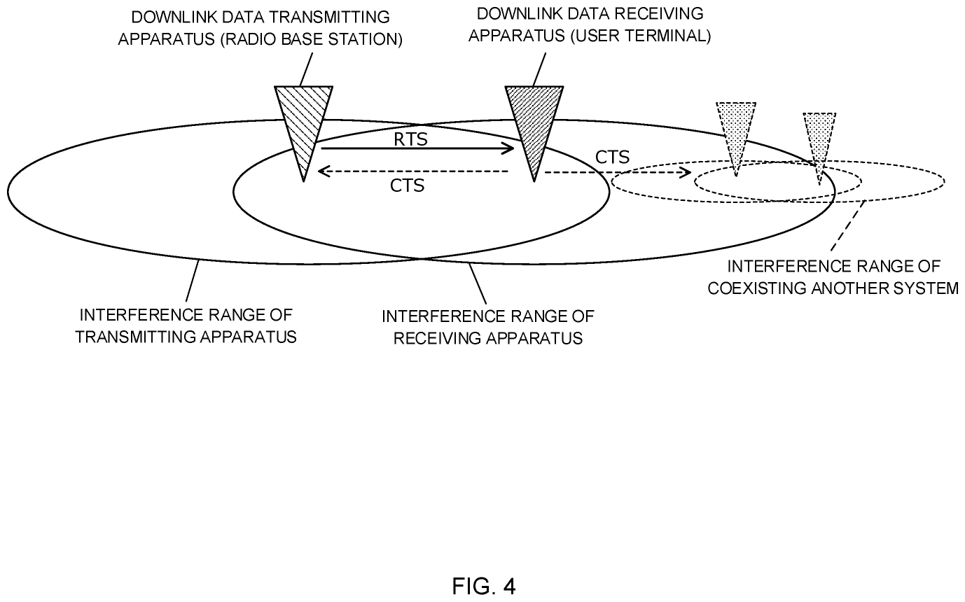

FIG. 4 is a diagram to show an example of the RTS/CTS in an NR-U system. In the NR-U system that supports the RTS/CTS, it is assumed that a transmitting apparatus (base station) transmits RTS on a carrier in an unlicensed band (referred to as an unlicensed carrier, an unlicensed CC, LAA SCell (Secondary Cell), and so on) before downlink data transmission to a receiving apparatus (user terminal).

When such an NR-U system supports an unlicensed CC for uplink, as shown in FIG. 4, it is conceivable that a downlink data receiving apparatus (user terminal) transmits CTS by using the unlicensed CC for uplink. In place of the unlicensed CC for uplink, an unlicensed CC for TDD (Time Division Duplex or unpaired spectrum) may be used.

A node (e.g., a base station (e.g., gNB) or UE) of NR-U obtains a transmission opportunity (TxOP or channel occupancy) to perform transmission when an LBT result is idle (LBT-idle), and does not perform transmission when the LBT result is busy (LBT-busy). The time of the transmission opportunity is referred to as Channel Occupancy Time (COT).

The COT is a total length of time for all transmissions in a transmission opportunity and a gap within given time, and may be equal to or less than a maximum COT (MCOT). The MCOT may be determined on the basis of channel access priority class. The channel access priority class may be associated with a contention window size.

The base station that has obtained the MCOT by performing LBT may perform scheduling relative to one or more UEs in a period with the MCOT.

The NR-U system may perform a carrier aggregation (CA) operation using the unlicensed CC and licensed CC, may perform a dual connectivity (DC) operation using the unlicensed CC and licensed CC, or may perform a stand-alone (SA) operation using only the unlicensed CC. CA, DC, or SA may be performed by a system of any one of NR and LTE. DC may be performed by at least two of NR, LTE, and another system.

UL transmission on the unlicensed CC may be at least one of a PUSCH, a PUCCH, and an SRS.

The node may perform, as LBT (initial LBT, initial-LBT (I-LBT)) for obtaining COT, LBT in LTE LAA or receiver assisted LBT. The LBT in LTE LAA in this case may be Category 4.

The UE may assume existence of a signal (e.g., a Reference Signal (RS) such as a Demodulation Reference Signal (DMRS)) in a PDCCH or group common (GC)-PDCCH for detection of a transmission burst from a serving base station. The PDCCH may be a PDCCH (UE specific PDCCH or regular PDCCH) for one UE. The GC-PDCCH may be a PDCCH (UE-group common PDCCH) common to one or more UEs.

At a start of COT triggered by the base station, the base station may transmit a specific PDCCH (PDCCH or GC-PDCCH) including a specific DMRS to notify the start of the COT. At least one of the specific PDCCH and specific DMRS may be referred to as a COT start notification signal. The base station may transmit the COT start notification signal to one or more specific UEs.

The UE may acknowledge the COT when detecting the specific DMRS.

The base station may schedule UL transmission in COT for the UE by using the specific PDCCH. The UE for which UL transmission in COT is scheduled may be referred to as the specific UE. The specific UE may be a UE for which UL signal (e.g., the first UL signal in COT) transmission in COT is scheduled.

For the NR-U, a hand-shake procedure between a transmitter and receiver is under study. The UE specified by the specific PDCCH achieves a hand-shake procedure between the base station and UE by transmitting a specific UL signal (response signal) such as an SRS, after LBT is under study.

Thus, for the NR-U, access schemes (receiver assisted access (RAA), hand-shake procedure, an access scheme using RTS/CTS, and a second access scheme) in which the specific PDCCH (COT start notification signal) is used just like the transmission request signal (RTS) and the response signal triggered by the specific PDCCH is used just like receivable state notification signal (CTS), and thus being close to CSMA/CA with RTS/CTS are under study.

For the NR-U, the UE that estimates a congestion degree in a band used by the base station by measuring received power at an arbitrary timing in accordance with an indication from the base station to notify the base station of a value of the measured received power (channel occupancy measurement) is under study.

Updating a contention window size (CWS) on the basis of transmission failure (e.g., an HARQ-ACK timeout, reception of negative acknowledgement (NACK), and the like) is under study. For example, the node that determines a value greater than a current CWS by one, out of a plurality of values of the CWS in response to the transmission failure is under study.

For the NR-U system, selecting an LBT procedure and selecting an LBT sub-band to be used by measuring channel congestion are under study.

When the CWS is updated in response to the transmission failure, large changes in environments such as the channel congestion may cause frequent collision. The more transmission is failed due to collision, the larger the CWS is, and the probability of obtaining a transmission opportunity is low, and thus unfairness may occur.

Thus, the inventors of the present invention came up with the idea of measuring received power in an unlicensed band to use the CWS based on the measurement.

Embodiments according to the present disclosure will be described in detail hereinafter with reference to the drawings. The radio communication methods according to respective embodiments may each be employed individually, or may be employed in combination.

In the present disclosure, a frequency, a band, a frequency band, a spectrum, a carrier, a component carrier (CC), a cell, a channel, a sub-band, an LBT sub-band, an active bandwidth part (BWP), and a part of an active BWP may be interchangeably interpreted.

In the present disclosure, listening, Listen Before Talk (LBT), Clear Channel Assessment (CCA), a carrier sense, sensing, and channel sensing or a channel access procedure may be interchangeably interpreted.

In the present disclosure, an NR-U frequency, an NR-U target frequency, an NR-U band, a shared spectrum, an unlicensed band, an unlicensed spectrum, an LAA SCell, an LAA cell, a primary cell (PCell, Primary Secondary Cell (PSCell), Special Cell (SpCell)), a secondary cell (SCell), and a frequency band in which channel sensing is applied may be interchangeably interpreted.

In the present disclosure, an NR frequency, an NR target frequency, a licensed band, a licensed spectrum, a PCell, a PSCell, an SpCell, an SCell, a non-NR-U frequency, Rel. 15, NR, and a frequency band in which channel sensing is not applied may be interchangeably interpreted.

Different frame structures may be used in the NR-U target frequency and NR target frequency.

A radio communication system (NR-U, LAA system) may be in compliance with a first radio communication standard (e.g., NR, LTE, and the like) (or may support the first radio communication standard).

Another system (coexisting system, coexisting apparatus) that coexists with this radio communication system and another radio communication apparatus (coexisting apparatus) may be in compliance with a second radio communication standard (or may support the second radio communication standard), the second radio communication standard being different from the first radio communication standard and being, for example, LTE, Wi-Fi, Bluetooth (registered trademark), WiGig (registered trademark), wireless Local Area Network (LAN), IEEE802.11, Low Power Wide Area (LPWA), and the like, or may support the first radio communication standard. The coexisting system may be a system that receives interference from the radio communication system, or may be a system that gives interference to the radio communication system.

In the present disclosure, transmission by a UE, UL transmission, a UL signal, a physical uplink shared channel (PUSCH), a physical uplink control channel (PUCCH), a sounding reference signal (SRS), an uplink (UL)-reference signal (RS), a preamble, a random access channel (RACH), and a physical random access channel (PRACH) may be interchangeably interpreted.

In the present disclosure, transmission by a base station, DL transmission, a DL signal, a physical downlink shared channel (PDSCH), a physical downlink control channel (PDCCH), a downlink (DL)-reference signal (RS), a demodulation reference signal (DMRS) for a PDCCH, and a DMRS for a PDSCH may be interchangeably interpreted.

In the present disclosure, a node, a UE, a base station, a transmission/reception point (TRP), a radio communication apparatus, and a device may be interchangeably interpreted.

In the present disclosure, a congestion index, a congestion degree, an occupancy level, and a usage rate may be interchangeably interpreted.

NR-U of the present disclosure is not limited to LAA, and may include a case where an unlicensed band is used in a stand-alone.

### (Radio Communication Method)

### Embodiment 1

A node may measure received power in an NR-U frequency band to perform transmission in the band on the basis of LBT within random time in a CWS based on the measurement (e.g., uniform random numbers from 0 to the CWS). The node may perform transmission when a result of the LBT is idle, and may not perform transmission when the result of the LBT is busy. When the node is a UE, the UE may perform UL transmission on the basis of the LBT.

The node may determine the CWS on the basis of a value obtained from the measurement. The node may transmit the value obtained from the measurement, and may receive an indication of the CWS based on the value. The UE may transmit the value obtained from the measurement to a base station, and may receive the indication of the CWS based on the value from the base station.

### <<Congestion Degree Computation Method>>

The node may compute a channel congestion degree in accordance with at least one of the following computation methods 1 to 4.

### <<<Computation Method 1>>>

The node may only perform Category 2 LBT (carrier sense) in a channel (band) in a period in which neither DL nor UL is scheduled, and may compute, as the congestion degree, the number of times busy is detected or the probability of detecting busy (busy detection rate R). The node may measure received power in the carrier sense, and may judge that the channel is busy when the received power exceeds a threshold value. The node may compute, as the busy detection rate R, a ratio of the number of times busy is detected to a given number of carrier senses.

A timing of performance of the carrier sense may not be timing before transmission. The timing of performance of the carrier sense may be a periodic timing, may be a semi-persistent timing, or may be an aperiodic timing.

According to this computation method 1, the method is simple, and thus a load on the node can be suppressed. It is possible to acquire the congestion degree with high precision.

### <<<Computation Method 2>>>

The node may only perform integration (carrier sense) of received power in the channel within certain time period in a period in which neither DL nor UL is scheduled, and may compute, as the congestion degree, a value of the integration of the power. The certain time period may be longer than time for the Category 2 LBT.

Information related to a timing and a length (window) of the carrier sense may be indicated for the UE by at least one of a downlink control channel (e.g., a GC-PDCCH or PDCCH) and higher layer signaling. The UE may determine the timing and the length (window) of the carrier sense for itself.

The node may perform the integration of the power in one or more windows. A length of one window may be the certain time period, or the sum of lengths of a plurality of discontinuous windows may be the certain time period.

According to this computation method 2, the method is simpler than computation method 1, and thus a load on the node can be suppressed. It is possible to acquire the congestion degree with precision according to computation method 1.

### <<<Computation Method 3>>>

The node may use an index indicating a degree (interference state) of existence of a hidden terminal as the congestion degree.

### <<<<Channel Occupancy Measurement>>>>

The node (at least one of the UE and the base station) may perform channel occupancy measurement (e.g., received power measurement) at a channel occupancy measurement timing (measurement timing).

The channel occupancy measurement timing may be a periodic timing, may be a semi-persistent timing, or may be an aperiodic timing.

The channel occupancy measurement timing may be indicated by at least one of periodicity, a starting position, and a time length. The starting position may be indicated by a slot position (e.g., a slot index) and an OFDM symbol position (e.g., a symbol index). The time length may be indicated by the number of symbols. The periodicity may be indicated by a specific time interval (a mini-slot, a slot, a subframe, a half-frame, a frame, and the like) or the number of specific time intervals. The channel occupancy measurement timing may be associated with an index (measurement timing index or channel occupancy measurement timing index). The channel occupancy measurement timing may be indicated by a triggering signal (e.g., a PDCCH or a PDSCH (MAC CE)). The channel occupancy measurement timing may be configured by higher layer signaling, and may be activated by the triggering signal.

The channel occupancy measurement timing may be given to an active bandwidth part (BWP).

The active BWP may be separated into one or more LBT sub-bands. The LBT sub-band may correspond to a channel band of a coexisting system (wireless LAN system), or may have a 20 MHz bandwidth corresponding to a channel of the coexisting system. The channel occupancy measurement timing may be given for each LBT sub-band. Each node may perform LBT in the LBT sub-band before transmission.

Information related to the channel occupancy measurement timing may be defined in specifications. An association between the measurement timing index and the channel occupancy measurement timing may be defined in the specifications.

Information (e.g., channel occupancy measurement configuration information, channel occupancy measurement timing configuration information) related to the channel occupancy measurement may be notified (configured or indicated) to the UE. The UE may measure received power on the basis of this notification. The information related to the channel occupancy measurement may be notified via higher layer signaling (e.g., at least one of RRC signaling and a MAC CE). The information related to the channel occupancy measurement may include information related to the channel occupancy measurement timing (time resource), or may include information related to a channel occupancy measurement band (frequency resource, for example, a BWP or an LBT sub-band).

The information to be notified may be a measurement timing index corresponding to one of a plurality of candidates of channel occupancy measurement timing. The plurality of candidates may be defined in the specifications, or may be notified by the higher layer signaling. The information to be notified may indicate the channel occupancy measurement timing by a relative position relative to an SS/PBCH block timing. The information to be notified may indicate the channel occupancy measurement timing for each LBT sub-band. The information to be notified may indicate the channel occupancy measurement timing for the active BWP.

The UE may determine the channel occupancy measurement timing for itself. The UE may select one candidate from the plurality of candidates of channel occupancy measurement timing, and may measure received power at the selected channel occupancy measurement timing. The plurality of candidates may be defined in the specifications, or may be notified by the higher layer signaling. Before the selected channel occupancy measurement timing, the UE may report a corresponding measurement timing index.

The node may store a channel occupancy state based on measured received power, the measurement timing index, and whether its own node is busy (or has transmitted a signal) at the channel occupancy measurement timing (a busy judgment result).

The channel occupancy state may be a received power value with the reduced amount of information obtained by quantizing the measured received power, or may be a received power judgment value indicating whether the measured received power exceeds a received power threshold value (busy) or not (idle).

The node may store channel occupancy states at a plurality of channel occupancy measurement timings.

When signal transmission at the channel occupancy measurement timing is scheduled, the UE may prioritize the signal transmission.

A plurality of nodes may perform channel occupancy measurement at the same channel occupancy measurement timing. Among the plurality of nodes, the channel occupancy measurement timings corresponding to one measurement timing index may be the same or different from each other. Among the plurality of nodes, the channel occupancy measurement timings corresponding to one measurement timing index may be synchronized, or may not be synchronized.

The node may measure a signal from the coexisting system (wireless LAN, NR-U of another carrier, LTE LAA, and the like) at the channel occupancy measurement timing. Periodicity of the channel occupancy measurement timing may be periodicity of a specific signal, such as periodicity of an SS/PBCH block having a specific index and the like.

### <<<<Report of Channel Occupancy Measurement>>>>

The node (at least one of the UE and the base station) may perform channel occupancy measurement at the channel occupancy measurement timing, and may report a notification message indicating a channel occupancy measurement result (measurement result).

The notification message may be transmitted on an unlicensed CC, or may be transmitted on a licensed CC.

The UE may notify the base station of the notification message (report the notification message to the base station). The notification message from the UE may be notified on at least one of a PUCCH (e.g., UCI, a CSI report, and the like) and a PUSCH (e.g., a MAC CE, a CSI report, a measurement report, and the like). A timing of the notification message may be a periodic timing, may be a semi-persistent timing, or may be an aperiodic timing. The timing of the notification message may be configured for the UE by the higher layer signaling. The UE may transmit the notification message in response to a request from the base station.

The base station may notify one or more UEs of the notification message. The notification message from the base station may be notified on at least one of a PDCCH (e.g., DCI and the like) and a PDSCH (e.g., a MAC CE and the like). The notification message from the base station may be a different unicast message for each UE, or may be a broadcast or multicast message to all UEs or some UEs connecting to the base station.

The notification message may include at least one of the measurement timing index, the channel occupancy state, a UE ID, a cell ID, and the busy judgment result. When the channel occupancy measurement timing is defined in the specifications or when the channel occupancy measurement timing is notified from the base station to the UE, the notification message from the UE may not include the measurement timing index.

The node may store contents based on the received notification message. The node may store contents based on the notification messages at a plurality of channel occupancy measurement timings.

### <<<<Report of Channel Occupancy Measurement>>>>

The node (at least one of the UE and the base station) may compute a difference between a first channel occupancy measurement result by its own node (measured by its own node) and a second channel occupancy measurement result received from another node (reported from another node or measured by another node).

The node may compute the difference between the first channel occupancy measurement result and the second channel occupancy measurement result for each channel occupancy measurement index.

When the channel occupancy state is the received power value, the node may compute a difference (power difference) between a received power value in the first channel occupancy measurement result and a received power value in the second channel occupancy measurement result. The node may compute unsigned power difference (absolute value) to count the number of times (occurrence frequency) the unsigned power difference exceeds a power difference threshold value. It is possible to estimate existence of the hidden terminal by using even the unsigned power difference. The node may compute signed power difference to count the number of times (first occurrence frequency) the signed power difference exceeds a positive power difference threshold value and the number of times (second occurrence frequency) the signed power difference falls below a negative power difference threshold value. In this case, the node may count the first occurrence frequency in a case where the hidden terminal exists when transmission in its own node is performed and the second occurrence frequency in a case where the hidden terminal exists when reception in its own node is performed.

When the channel occupancy state is the received power judgment value, the node may compute a difference (difference in the received power judgment value or judgment difference) between a received power judgment value in the first channel occupancy measurement result and a received power judgment value in the second channel occupancy measurement result. The node may compute unsigned judgment difference (absolute value) to count the number of times (occurrence frequency) the unsigned judgment difference exceeds a judgment difference threshold value. It is possible to estimate existence of the hidden terminal by using even the unsigned judgment difference. The node may compute signed judgment difference to count the number of times (first occurrence frequency) the signed judgment difference exceeds a positive judgment difference threshold value and the number of times (second occurrence frequency) the signed judgment difference falls below a negative judgment difference threshold value.

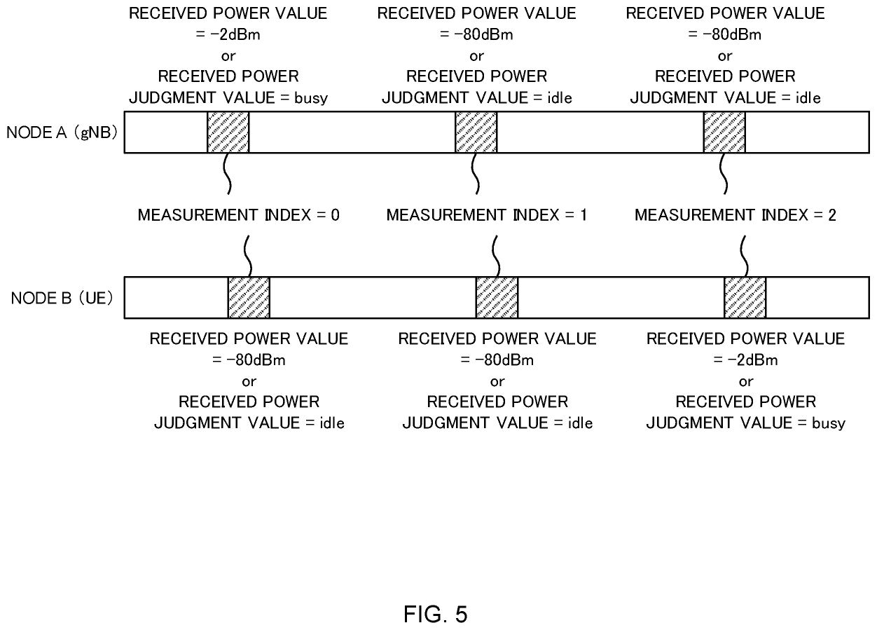

In an example of FIG. 5, a node A is the base station and a node B is the UE. The node A measures received power at measurement timings (measurement timing indices=0, 1, and 2) to store the measurement result. The node B measures received power at measurement timings (measurement timing indices=0, 1, and 2) to report the measurement result to the node A.

When the channel occupancy state is the received power, the power difference threshold value is 40 dB, and the base station computes the unsigned power difference, at measurement timing indices 0 and 2, power difference between the node A and the node B exceeds the power difference threshold value, and thus the node counts the occurrence frequency.

When the channel occupancy state is the received power judgment value, the received power threshold value is −40 dBm, and the base station computes the unsigned judgment difference, at measurement timing indices 0 and 2, received power judgment values are different from each other between the node A and the node B, and thus the node counts the occurrence frequency.

Moreover, the node may judge whether the channel occupancy state includes influence of transmission in its own node by storing channel occupancy states and busy judgment results in its own node and peripheral node. The node may count the first occurrence frequency in a case where the hidden terminal exists when transmission in its own node is performed (in a case where its own node is busy) and the second occurrence frequency in a case where the hidden terminal exists when reception in its own node is performed (in a case where its own node is not busy).

The node may compute a moving average of the occurrence frequency. The node may update the moving average at each channel occupancy measurement timing on the basis of a measurement result and a reception result. The moving average may be at least one of a simple moving average, a weighted moving average, and an exponential moving average. The node may compute the moving average of the occurrence frequency through a plurality of channel occupancy measurement indices.

A parameter for computation of the moving average (e.g., from how many seconds before the occurrence frequency is to be enabled, the number of samples to be averaged, the power difference threshold value, the judgment difference threshold value, a weighting factor, a weighting function, an exponent, and the like) may be defined in the specifications, or may be notified (configured) from the base station. The base station may determine the parameter on the basis of at least one of quickness of changes in environments and a moving speed of the UE to notify the UE of the parameter.

Quickness of fluctuation in the number of times (which may be referred to as frequency, the probability, a congestion degree, and so on) the channel is busy may be computed as the quickness of changes in environments depending on channel occupancy measurement results by the base station at a plurality of channel occupancy measurement timings. The moving speed may be a moving speed measured by the UE, may be a moving speed assumed for the UE, or may be a moving speed determined on the basis of a network to be connected.

Each node (e.g., the UE) may report an instantaneous value of the occurrence frequency, and a node (e.g., the base station) that receives the instantaneous values from a plurality of nodes may compute a moving average of the instantaneous values.

The node may compute the probability of occurrence of difference between measurement results in nodes on the basis of the occurrence frequency or the moving average.

The node may use at least one of the occurrence frequency, the moving average, and the probability of the occurrence as an index indicating a degree (interference state) of existence of the hidden terminal. The node may judge whether influence from the hidden terminal is present (the hidden terminal exists to a certain extent) on the basis of the index. The node may judge whether or not to use the second access scheme on the basis of the index. The node may use the second access scheme when the index exceeds an index threshold value. The node may use the first access scheme when the index does not exceed the index threshold value. The base station may judge whether or not to use the receiver assisted access on the basis of the index to notify the UE of the judgment result.

The node may receive notification indicating whether or not to use the second access scheme (may receive information (e.g., higher layer signaling or a specific PDCCH) indicating an access scheme) depending on a report of the measurement result.

The base station can reduce interference due to the hidden terminal by using the second access scheme when the hidden terminal exists to a certain extent, and otherwise can reduce overhead by using the first access scheme, thereby allowing utilization efficiency of radio resources to be enhanced.

The node may acknowledge interference relationship (interference state) between nodes on the basis of the index. When a plurality of nodes performs channel occupancy measurement at the same channel occupancy measurement timing, a node may compute the index for each two nodes to identify the hidden terminal for each node on the basis of the index. The base station performs scheduling taking the interference relationship into consideration, and thus, for example, it is possible not to spatially multiplex with each other nodes that give interference, and to spatially multiplex with each other nodes that do not give interference. Therefore, utilization efficiency of radio resources can be enhanced.

The node may compute the index for each LBT sub-band. The base station performs scheduling taking the index for each LBT sub-band into consideration, and thus, for example, can schedule avoiding a specific LBT sub-band, thereby allowing utilization efficiency of radio resources to be enhanced.

The node may compute the index in a case where the hidden terminal exists when transmission in its own node is performed and the index in a case where the hidden terminal exists when reception in its own node is performed. The base station may perform scheduling taking the index in the case where the hidden terminal exists when transmission in its own node is performed and the index in the case where the hidden terminal exists when reception in its own node is performed into consideration.

The node may compute, on the basis of a channel occupancy measurement result by its own node, an index indicating a degree of existence of the hidden terminal to use the index as the congestion degree.

According to this computation method 3, a procedure for computing the index indicating a degree of existence of the hidden terminal is available, and thus a load on the node can be suppressed. It is possible to acquire the congestion degree with precision equivalent to computation method 1.

### <<<Computation Method 4>>>

The node may compute, on the basis of the channel occupancy measurement result by its own node, mentioned in computation method 3, and a channel occupancy measurement result by another node, an index indicating a degree of existence of the hidden terminal to use the index as the congestion degree.

According to this computation method 4, frequency of transmission in environments in which a multitude of hidden terminals exists (collision easily occurs) can be suppressed, thereby allowing overall system performance to be enhanced.

### <<CWS Update Method>>

The node may update the CWS on the basis of a congestion parameter obtained by at least one of above-described computation methods 1 to 4.

The node may update the CWS in accordance with at least one of following update methods 1 to 6.

### <<<Update Method 1>>>

A plurality of ranges of the congestion parameter may be associated with a plurality of values of a CWS parameter, respectively. The congestion parameter may be the congestion degree. The CWS may be time obtained by multiplying the CWS parameter CW by a slot time length (duration) Tₛₗ. Tₛₗ may be 9 μs.

Each node may compute the congestion parameter to judge in which range the computed congestion parameter is, and may determine a corresponding CWS parameter and determine the CWS on the basis of the CWS parameter.

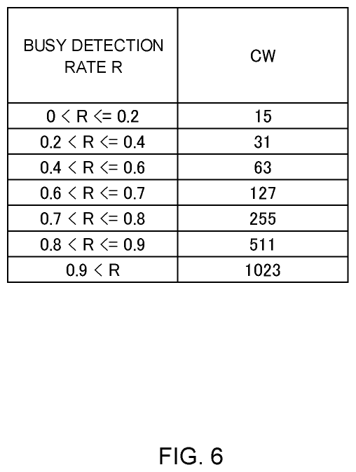

FIG. 6 is a diagram to show an example of an association between ranges of the congestion parameter and values of the CWS parameter.

This example shows a case where LBT priority class is 4 and the congestion parameter is the busy detection rate R. The lower the LBT priority class is (the higher a value of the LBT priority class is) or the longer LBT is, the longer obtainable COT is. LBT priority class 4 corresponds to the lowest priority, the longest CWS, and the longest MCOT.

Each node can determine the CWS on the basis of the congestion parameter measured by itself, and thus signaling overhead related to the congestion parameter can be suppressed.

### <<<Update Method 2>>>

Each node may compute a congestion degree to transmit the computed congestion degree to the base station. The base station may compute, as the congestion parameter, an average value of congestion degrees of at least one of a connected UE and the base station itself.

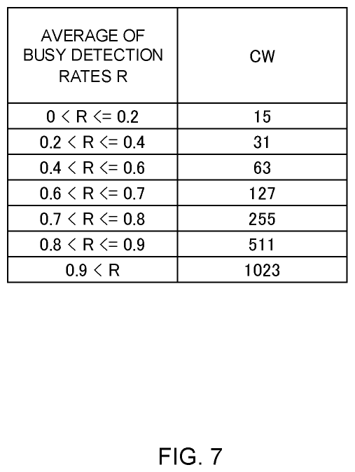

FIG. 7 is a diagram to show another example of the association between ranges of the congestion parameter and values of the CWS parameter. In this example, the congestion parameter is an average value of busy detection rates R.

Similarly to FIG. 6, a plurality of ranges of the congestion parameter may be associated with a plurality of values of the CWS parameter. The base station may judge in which range the congestion parameter is, and may determine a corresponding CWS parameter and determine the CWS on the basis of the CWS parameter.

The base station may notify the UE in a cell of information related to the determined CWS. For example, the base station may notify the information related to the determined CWS by using a GC-PDCCH (e.g., COT start notification signal). The UE to which the information related to the CWS has been notified may perform LBT by using the CWS based on the information.

Matching the CWSs in the cell allows fairness between nodes in the cell to be assured.

### <<<Update Method 3>>>

Each node may compute a congestion degree to transmit the computed congestion degree to the base station. The base station may acquire congestion degrees of nodes in its own cell to transmit the congestion degrees of the nodes in its own cell to another base station via the network. The base station may acquire the congestion degrees of the nodes in its own cell, and may compute an average value of the congestion degrees of the nodes in its own cell to transmit the average value to another base station via the network.

Similarly to FIG. 6, a plurality of ranges of the congestion parameter may be associated with a plurality of values of the CWS parameter.

A representative base station that serves as a representative of a group of a plurality of base stations may be configured. The representative base station may acquire congestion degrees in the group or average values computed by the plurality of base stations to compute, as the congestion parameter, an average value of the acquired values.

The representative base station may judge in which range the congestion parameter is, and may determine a corresponding CWS parameter and determine the CWS on the basis of the CWS parameter. The representative base station may notify a base station in the group of information related to the determined CWS. The base station may notify the UE in a cell of information related to the determined CWS. For example, the base station may notify the information related to the determined CWS by using a GC-PDCCH (e.g., COT start notification signal). The UE to which the information related to the CWS has been notified may perform LBT by using the CWS based on the information.

Matching the CWSs in the group allows fairness between nodes in a plurality of cells to be assured regardless of whether the UE is connected to one cell.

The base station may acquire congestion degrees of a peripheral cell or an average value of the congestion degrees via the network to compute, as the congestion parameter, an average value of the congestion degrees of its own cell and the congestion degrees of the peripheral cell.

The base station may notify the UE in a cell of information related to the determined CWS. For example, the base station may notify the information related to the determined CWS by using a GC-PDCCH (e.g., COT start notification signal). The UE to which the information related to the CWS has been notified may perform LBT by using the CWS based on the information.

In this case, the CWS may be different for each cell.

Determining the CWS taking congestion degrees of its own cell and peripheral cell into consideration allows fairness between nodes in a plurality of cells to be enhanced.

### <<<Update Method 4>>>

A plurality of ranges of the congestion parameter may be associated with a plurality of candidates of CWS update method.

The node may judge in which range the congestion parameter computed by any one of update methods 1 to 3 is to determine a corresponding CWS update method.

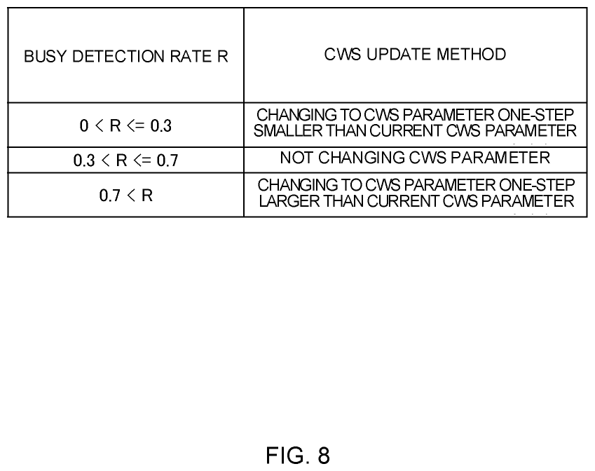

As shown in FIG. 8, the plurality of candidates of CWS update method may include at least one of updating a CWS parameter value to a CWS parameter (CW_{P}) value one-step smaller than the current CWS parameter value, not changing a CWS parameter value, and updating a CWS parameter value to a CWS parameter value one-step larger than the current CWS parameter value. A plurality of steps for CWS parameter may be configured. The plurality of steps for the CWS parameter may include at least one of 15, 31, 63, 127, 255, 511, and 1023.

The smallest CWS parameter and the largest CWS parameter may be configured. When the CWS parameter is updated to a CWS parameter smaller than the smallest CWS parameter by the determined CWS update method, the node may determine the next CWS parameter as the smallest CWS parameter. When the CWS parameter is updated to a CWS parameter larger than the largest CWS parameter by the determined CWS update method, the node may determine the next CWS parameter as the largest CWS parameter.

According to this update method 4, it is possible to update the CWS with the congestion parameter in a step-by-step manner. It is possible to update the CWS gradually even when the congestion degree changes rapidly.

### <<<Update Method 5>>>

The node may update the CWS on the basis of the latest congestion parameter at every congestion parameter measurement. Therefore, the latest measurement result can always be reflected in the CWS.

The node may update the CWS on the basis of a congestion parameter obtained from the latest measurement set at every preconfigured measurement set (a plurality of measurements). Therefore, frequency of at least one of updating and signaling can be suppressed.

### <<<Update Method 6>>>

The node may use a first CWS update method using at least one of above-described update methods 1 to 4 and a second CWS update method other than the first CWS update method.

The second CWS update method may update the CWS on the basis of communication failure. For example, the second CWS update method may update the CWS on the basis of a result of HARQ-ACK reception (HARQ-ACK timeout, NACK, and the like).

The node may have priority to use the first CWS update method.

The node may have priority to use the second CWS update method, and may use the first CWS update method when the CWS is not updated by the second CWS update method.

When there is no coexisting system that uses the same frequency and cannot communicate with an NR-U system, only the first CWS update method may be used for the node.

According to this update method 6, it is possible to flexibly configure the CWS update method.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

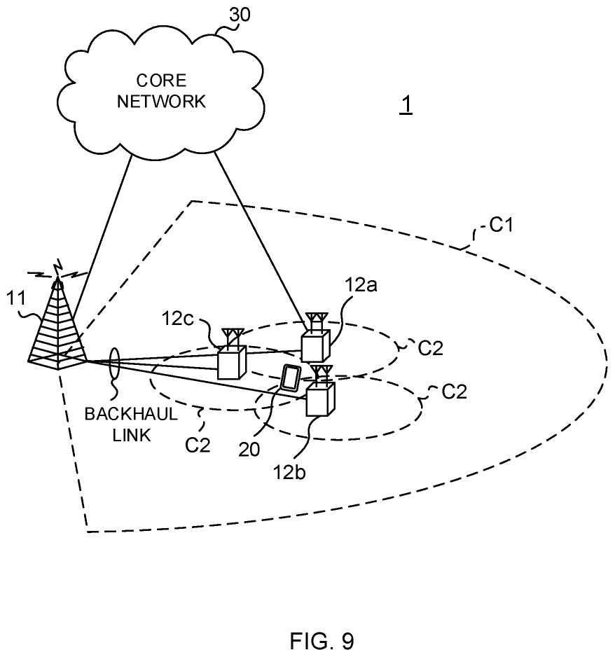

FIG. 9 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

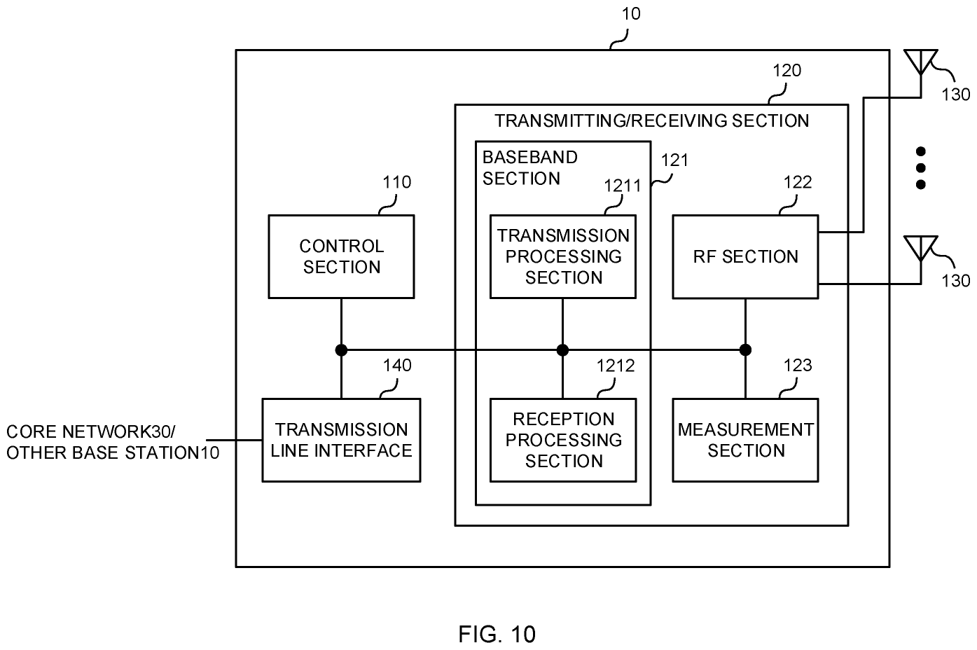

FIG. 10 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120 and the transmitting/receiving antennas 130.

### (User Terminal)

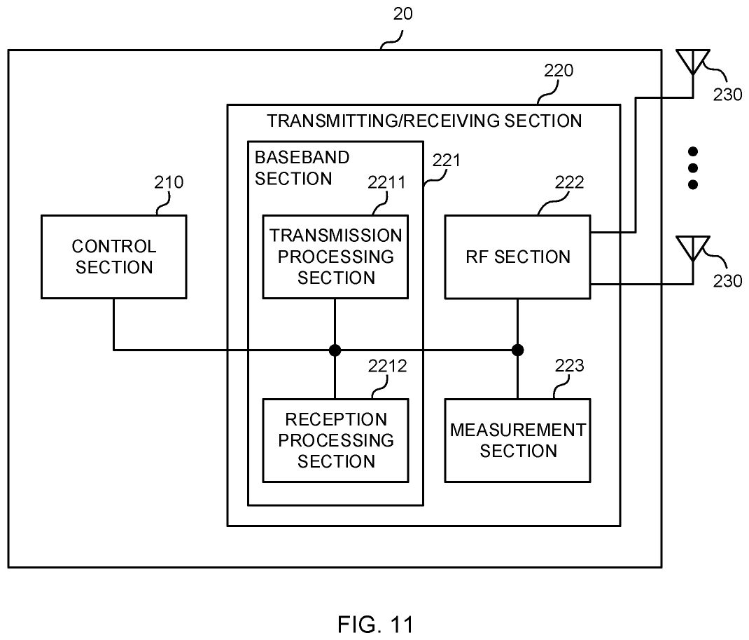

FIG. 11 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220, the transmitting/receiving antennas 230, and the communication path interface 240.

The transmitting/receiving section 220 may measure received power in a frequency (e.g., an NR-U frequency) in which sensing of a channel is applied. The control section 210 may perform transmission in the frequency on the basis of the sensing within random time in a contention window size (CWS) based on the measurement.

A plurality of ranges of a value obtained from the measurement may each be associated with a plurality of candidates for the CWS or a plurality of methods for updating the CWS.

The control section 210 may determine the CWS on the basis of a value (e.g., a congestion degree or a congestion parameter) obtained from the measurement.

The control section 210 may transmit a value (e.g., a congestion degree or a congestion parameter) obtained from the measurement, and may receive an indication of the CWS based on the value.

The CWS may be based on an average value of values measured by a plurality of nodes including the user terminal.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

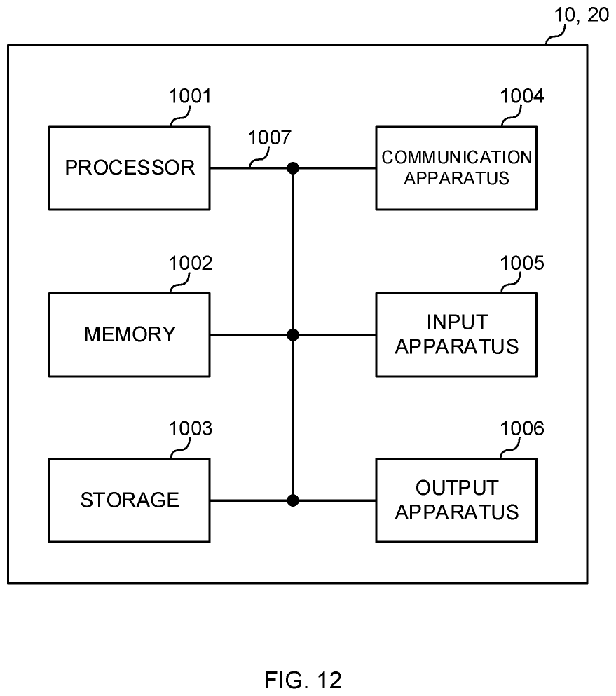

For example, a base station, a user terminal, and so on according to one embodiment of the present disclosure may function as a computer that executes the processes of the radio communication method of the present disclosure. FIG. 12 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of given information (for example, reporting of “X holds”) does not necessarily have to be reported explicitly, and can be reported implicitly (by, for example, not reporting this given information or reporting another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a mobile body or a mobile body itself, and so on. The mobile body may be a vehicle (for example, a car, an airplane, and the like), may be a mobile body which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A user terminal comprising:
a receiving section that measures received power in a frequency in which sensing of a channel is applied; and
a control section that performs transmission in the frequency on the basis of the sensing within random time in a contention window size (CWS) based on the measurement.

2. The user terminal according to claim 1, wherein a plurality of ranges of a value obtained from the measurement is associated with a plurality of candidates for the CWS or a plurality of methods for updating the CWS.

3. The user terminal according to claim 1, wherein the control section determines the CWS on the basis of a value obtained from the measurement.

4. The user terminal according to claim 1, wherein the control section transmits a value obtained from the measurement, and receives an indication of the CWS based on the value.

5. The user terminal according to claim 4, wherein the CWS is based on an average value of values measured by a plurality of nodes including the user terminal.

6. A radio communication method for a user terminal comprising:
measuring received power in a frequency in which sensing of a channel is applied; and
performing transmission in the frequency on the basis of the sensing within random time in a contention window size (CWS) based on the measurement.

7. The user terminal according to claim 2, wherein the control section determines the CWS on the basis of a value obtained from the measurement.

8. The user terminal according to claim 2, wherein the control section transmits a value obtained from the measurement, and receives an indication of the CWS based on the value.
